(19) United States
(12) Patent Application Publication
(10) Pub. No.: US 2018/0026475 A1
(43) Pub. Date: Jan. 25, 2018

(54) ELECTRICAL DEVICE INSTALLATION MONITORING IMPROVEMENT

(71) Applicant: Embertec Pty Ltd, Dulwich, South Australia (AU)

(72) Inventors: Domenico Gelonese, Dulwich, South Australia (AU); Riccardo Gatto, Dulwich, South Australia (AU)

(21) Appl. No.: 15/547,272

(22) PCT Filed: Jan. 27, 2016
(86) PCT No.: PCT/AU2016/000015

§ 371 Date: Jul. 28, 2017

(30) Foreign Application Priority Data
Jan. 30, 2015 (AU) 2015900280

(51) Int. Cl. H02J 9/00; G05B 15/02; H04L 29/06; H02J 13/00

(52) U.S. Cl. CPC H02J 9/005; H02J 13/0075; G05B 15/02; H04L 63/0876; H04L 63/126

(57) ABSTRACT

An energy saving device for installation in a household, the energy saving device including′ a communications module used to transmit identification data and usage data to a monitoring entity for energy savings measurement and verification purposes. The identification data includes a unique identifier o of the energy saving device. The unique identifier is combined, with a geographical location of the premises to form a verification code.

### FIELD OF THE INVENTION

The present invention relates to an apparatus and method for the verification of installation of electrical equipment, in particular verification acceptable to a party not being an installer of the electrical equipment.

### BACKGROUND

When a user installable electrical device is installed typically the device is plugged into a suitable outlet that is connected to the mains electrical supply. This is usually a wall outlet, sometimes referred to as a general purpose outlet (GPO), but can also be a power extension board or similar. Verification of the installation, if required, requires no more than the observation, by the installer, that the most basic functions of the device are operational.

Most current electrical devices, and in particular computer and audio visual (AV) devices have a number of power states, such as on, off and standby. The standby power state is one that keeps the electrical device powered to be able to receive a signal, such as a signal from a remote control device, so that it moves to the on power state very quickly. A known shortcoming with standby power state is that power is still being consumed, albeit less than the power being consumed when the device is in the on state. Users of such devices typically leave the device in standby mode for lengthy periods of time, without considering the power use in the standby power state. The resultant use of power in the standby mode can be significant, more so when the number of devices is taken into consideration.

Standby power supply control devices, such as those referred to in WO 2008/064410, which is hereby incorporated by reference, are very useful in such situations as they are able to determine that an electrical device is not in use, which may be in standby power mode or may be when inadvertently left on in full power mode but without being in use, for long periods of time, and are able to cut power to those devices that are connected to the power supply control device without necessarily having any interaction from the user.

These power supply control devices are usually positioned between the GPO and the electrical devices. The installation of these devices can be carried out by either by a qualified installer or by a domestic user.

Standby power supply control devices are often included as part of energy saving incentives backed by such entities as energy retailers, energy distributors energy generators and government bodies. Incentives, which may be free or subsidised supply of the devices, reductions in power bills or any other acceptable incentive, are provided by the entity to a householder in an attempt to encourage the householder, be they domestic or commercial, to acquire such devices and to install the devices in a manner such that a reduction in energy use by the householder is likely to occur. Not every possible installation of the devices will be likely to bring about power savings. The entities wish only to provide the incentives in cases where the devices are installed appropriately, with appropriate electrical equipment such as computer or AV equipment. Electrical devices such as lamps or toasters may not be considered as appropriate electrical equipment due to their infrequent use for long periods of time and/or their lack of a standby power state.

A shortcoming in such incentive schemes is that the entity providing the incentive has great difficulty in verifying that the energy saving devices have been installed in the appropriate manner and are able to provide a reduction in energy usage. If the energy saving device is installed by a qualified installer there is a greater level of confidence that the device is installed correctly so long as the installer is competent and trustworthy. Achieving this level of confidence requires that the installer be trained, and that the installer does not make mistakes, nor engage in fraudulent behaviour.

If the energy saving device is installed by the householder, then there is comparatively less confidence that that the device has been installed correctly. All that can be known with certainty is that the energy saving device has been purchased by or supplied to the householder.

Such incentive schemes are open to exploitation as there is no present way available to positively verify correct installation and ensure that the energy saving device is in active use and capable of saving or reducing energy consumption apart from undertaking a physical audit of installations. Such audits are expensive and time consuming and therefore it is not viable to audit every installation that has been undertaken. The result is a low level of confidence that the energy saving devices have actually been installed and installed correctly.

Throughout this specification, the term “qualified installer” refers to a person or company authorised to install the energy saving device.

### SUMMARY OF THE INVENTION

In one form of the invention, it may be said to reside in an energy saving device adapted to be installed in premises, the energy saving device including a communication module adapted to communicate a verification code to a verification program running on a co-located processing device upon successful installation of the energy saving device.

In a further form there is an energy saving device for installation in a household, the energy saving device including a communications module used to transmit identification data and usage data to a monitoring entity for energy savings measurement and verification purposes.

2 In preference, the identification data includes a unique identifier of a communication transceiver of the energy saving device.

In preference, the unique identifier is combined with a geographical location of the premises to form a verification code.

In preference the energy saving device is a standby power controller.

In preference the communications module is adapted to communicate with a wireless router of the household in order to establish a connection via the public internet to the monitoring entity.

In preference the communications module is adapted to communicate with a cellular data network in order to establish a connection via the public internet to the monitoring entity.

In preference the communications module is adapted to communicate with a mobile computing device, said mobile computing device communicating with a remote monitoring entity.

In preference the mobile computing device is a smartphone.

In a further form the energy saving device is adapted to be connected to a power outlet and to be further connected at least one electrical device, said electrical devices drawing power through the energy saving device, the energy saving device including a testing means adapted to perform at least one installation verification test and a communication means adapted to communicate a validation signal to a monitoring entity when a result of the installation verification test indicates that a correct installation has occurred.

In preference the testing means includes a processor adapted to monitor the power drawn through the energy saving device and to determine that the changes in that power follow a predetermined acceptable pattern indicating a correct installation.

In preference the acceptable pattern is chosen to be a pattern which indicates that the at least one electrical device is of a predetermined acceptable type which form a correct installation.

In preference the verification code is unique to the individual energy saving device.

In preference, the verification code is a MAC code associated with the energy saving device or a component thereof.

In a further form the invention lies in a method of verifying an installation of an energy saving device, the method including the steps of an installer installing the energy saving device in between a mains electrical power outlet and a least one electrical device the energy saving device measuring power drawn by the electrical device and determining that changes in that power drawn are of a pattern which demonstrates that the electrical devices connected to the energy saving device are of type to constitute a correct installation of a plug of the energy saving device.

In a further form there is practiced a method for measurement and verification of energy savings including the steps of installing a standby power controller in a household the standby power controller transmitting usage data describing the functioning of the standby power controller over time to a remote monitoring entity, the usage data being analysed to determine the energy savings which can be attributed to the installation of the standby power controller.

In preference an incentive paying third party pays an incentive for the installation of the standby power controller, the incentive paying third party determining the success of the installation based on the determined energy savings.

The invention may also be said to lie in a method of verifying the continued operation of an energy saving device including periodically communicating a verification code to a verification program adapted to communicate a validation signal to a monitoring entity.

### BRIEF DESCRIPTION OF THE DRAWINGS

By way of example, embodiments of the invention are described more fully hereinafter with reference to the accompanying drawings, in which:

FIG. 1 is an illustration of an energy saving device incorporating the invention;

FIG. 2 is a diagrammatic representation of an installation including an energy saving and a monitoring entity;

FIG. 3 is a diagrammatic representation of installer hardware deployment;

FIG. 4 is a flowchart of an installer installation of an energy saving device;

FIG. 5 is a flowchart of a self-install of an energy saving device;

FIG. 6 is a flow chart of an installation showing ongoing measurement and verification;

FIG. 7 is a flow chart showing a self-install with integrated testing;

FIG. 8 is a flow chart showing a self-install with ongoing incentive payments.

### DETAILED DESCRIPTION OF THE INVENTION

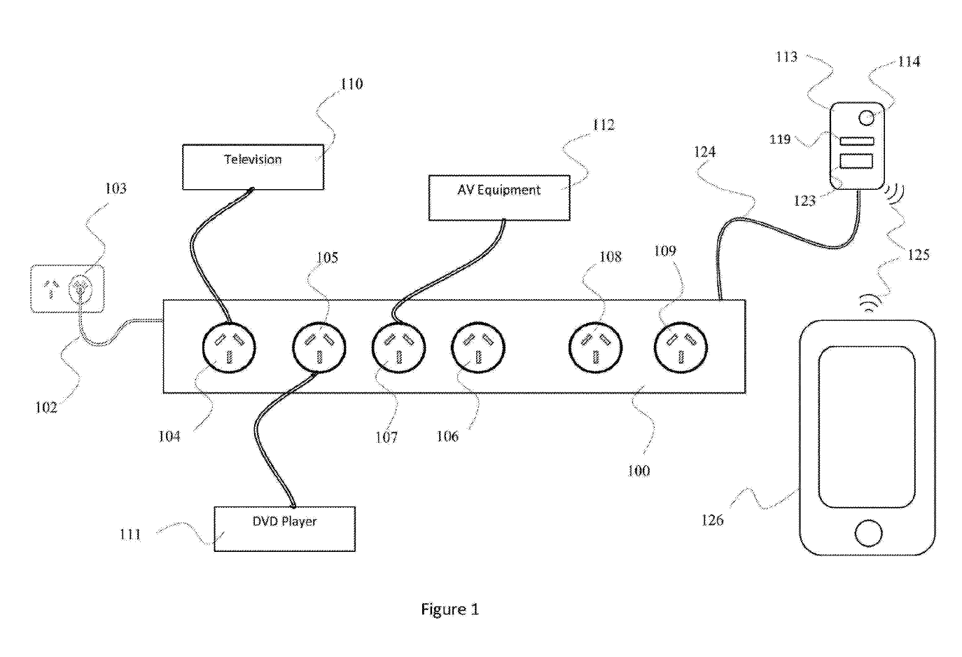

Referring first to FIG. 1, it is to be understood that this is a general representation of an installation including a standby power controller (SPC) including the invention and is illustrative only. It is not intended to limit the number or configuration of continually powered or switched or monitored main outlets, or of communication interfaces or other functional modules.

FIG. 1 shows a representation of an energy saving device in the form of an SPC. An SPC is an energy saving device which is installed in between the mains power supply and an electrical device. For example, it is common that electrical devices such as AV equipment and computer equipment are “turned off” by being changed to a standby power state, which reduces, but does not eliminate, power consumption. Energy savings may be achieved by powering these types of devices by plugging them into an SPC. In some instances one of these attached electrical devices may be considered to be the main device, in that if the main device is off or in a standby state then all other devices, referred to as slave devices, attached to the SPC should be off. It may or may not be the case that power should also be withdrawn from the main device. In particular power may not be withdrawn where the main device is a computer.

In other cases, when a main device, for example a television, is in a standby state, it is desirable to remove power from the main device and any associated electrical devices. This is common where there is a subset of electrical devices such as televisions, video equipment, personal video recorders (digital video recorders), CD players, stereo systems, amplifiers, pay-television boxes and other AV equipment grouped into close proximity and often used in combination with each other.

The SPC 100 of FIG. 1 is adapted for use with AV equipment. The SPC 100 receives electrical power from a General Purpose Outlet 103, via power cord 102.

The SPC includes Monitored and Controlled Outlets 104,105,106, 107. The SPC also includes Uncontrolled Outlets 108, 109. In general, any number of Monitored and Controlled outlets and Uncontrolled Outlets may be provided. In an embodiment, the Uncontrolled(s) outlet may be absent.

Monitored and Controlled Outlet 104 supplies electrical power to a television 110. Further Monitored and Controlled Outlets 105, 106 may provide electrical power to other audio-visual equipment, for example a DVD player 111 and audio equipment 112. In an embodiment having only one Monitored and Controlled outlet, multiple devices may be powered from the one outlet using a powerstrip. In any embodiment, multiple devices may be powered from one Monitored and Controlled outlet using a powerstrip.

The SPC includes a Sensing and Communications Unit 113. In a preferred embodiment, this unit is in data communication with the body of the SPC via cable 124, which may also provide power to the Sensing and Communications Unit 113. The Sensing and Communications Unit 113 also includes a remote communication means, in the illustrated embodiment a Bluetooth transceiver 123. The cable 124 may be a fixed connection or may be plug connected at one or both ends. In other embodiments, the cable may be replaced with any convenient wireless connection. In a further embodiment, the Sensing and Communications Unit may be integrated with the SPC body. In further embodiments, the remote communication 123 means may be provided by any convenient wireless protocol, including without limitation, wifi, ZigBee and RF4CE.

Modern television sets and other audio visual equipment, when turned “off” by the remote control, enter a low power “standby” state, in which energy is still consumed, although at a significantly lower level that when the device is nominally “on”. When the television is in this standby state it is not in use, and the power supply to it may be cut to save energy.

It is also the case that television sets may be left on for extended periods when no user is viewing the screen. This may happen when a user falls asleep in front of the television, or when a user, particularly a child or a teenager, simply leaves the vicinity of the television without turning the television off. This state may be termed “active standby”. In this state the television is not in use, and the power supply to it may be cut to save energy.

The SPC may detect that the television has entered a standby state by any convenient means or combination of means.

In order to save energy the SPC operates to remove the power supply from Monitored and Controlled outlet 104 and hence from the attached television, whenever the television is detected to not be in use, whether in a low power standby state or an active standby state. Power may also be removed from all other Controlled outlets, since the devices powered through those outlets are in use only when the television is in use.

The SPC includes a power sensor adapted to sense the power drawn through a Monitored and Controlled outlet. The power sensor detects characteristics of the power flow through the outlet. When the characteristic is such as to indicate that the television is in a standby state the power to the Monitored and Controlled outlet 104, and hence to the attached television or monitor is interrupted.

The SPC may include any number of Monitored and Controlled outlets, which may be monitored and controlled individually or together.

The SPC may include means to detect that a user is interacting with the audio visual equipment and/or the television. The sensing and communications unit 113 includes an infra-red sensor 119. This sensor 119 receives IR signals from a remote control associated with the television or other connected AV equipment.

It is likely that a user, when actively watching television, will periodically use the remote control to change channels, adjust volume, mute commercials, etc. Thus a remote control signal receiver, such as IR sensor 119 can be used as a usage sensor. If no remote control activity is detected by the IR sensor 119 for a period of time, the assumption may be made that the television is not in use, and the power supply to the Monitored and Controlled outlet 104, and hence to the television, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero there has been no remote control activity for the time period, the television is therefore assumed to not be in active use, that is to be in an active standby state and the electricity supply to the Monitored and Controlled outlet 104, and hence to the television, is interrupted. In a preferred embodiment, the supply of electricity to all Monitored and Controlled Outlets is interrupted at the same time.

It may be sufficient to determine that a user is present in the vicinity of the television in order to decide that the television should not be turned off. Any suitable sensor may be used for determining that a user is present and thus that power to the television should not be interrupted. These include, without limitation, passive IR sensors, ultrasonic sensors, cameras, any other passive or active movement sensors, and sound detectors.

Whatever means is used to determine that the television is on, but not in use, it is unlikely to be completely free of false positives, that is, determining that the television is in active standby and not in use when the television is in fact in use. If the television is turned off when a user is still watching a program, the user will be irritated. Repeated occurrences are likely to lead to the power control function of the SPC being bypassed, preventing power savings.

The Sensing and Communications Unit 113 includes a warning LED 114. When the SPC determines that the television is in active standby, the warning LED will flash to alert any user to the imminent shutdown of the power to the television. In the case where there is a false positive, that is, there is a user watching the television, the user may react to observing the flashing of the warning LED by pressing a key on the remote control. The IR signal from the remote control is detected by the IR sensor 119, and the countdown timer is reset, preventing the power to the television being interrupted.

Other methods for warning of imminent shutdown of power to the television may be used. An audible warning tone may sound.

The SPC may include software allowing control of the warning mechanism. The brightness of the LED may be variable. It may be possible to set times when the warning should take certain forms. For example, an audible warning may be used at certain times of the day, whilst the LED is used at other times, or both may be used together at given times. At still further times, no warning at all may be given.

Uncontrolled power outlets 108, 109 are optionally provided to allow for power to be supplied to devices which should not have the power supply cut when the television is not in use. This outlet supplies power at all times when the SPC is plugged in. Any number of uncontrolled outlets may be provided.

Devices other than a television may be connected along with a television to the Monitored and Controlled outlets. In this case, the total load of all devices will be monitored for the characteristics indicating that all devices so connected are in a standby or unused state.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the monitored and controlled outlets 104-107, power is also interrupted to this outlet. A fourth type of outlet (not illustrated) is monitored, but not controlled. The power drawn through this outlet contributes to the determination that the monitored load is in a standby or unused state. However, the SPC does not interrupt power to this outlet. This is similar to the “main” outlet in a standard “main/slave” SPC, known in the art.

The remote communication means 123 provides a data link to processing devices external to the SPC. An external device may provide a user interface for the SPC, enabling a user to monitor and/or control some functions of the SPC.

There is provided Bluetooth transceiver 123 which provides data link 125 to an external processing device, in the illustrated embodiment, a smartphone 126. In other embodiments, without limitation, the processing device may be a tablet computer or a desktop computer.

The smartphone 126 runs an App (a program) which provides a user interface for the SPC. This user interface allows a user to control settings of the SPC. Settings may include the countdown time before power is removed when no IR activity is detected. The user interface may also be used to activate and deactivate the power saving functions of the SPC.

The user interface may also allow scheduling control of the SPC. This may be used to ensure that the SPC does not interrupt power during particular times. It might be used as a parental control, whereby the power to a television used by a child is switched off after a particular length of time or at a particular time to control viewing by the child.

There are third parties, other than the users or suppliers of energy saving devices such as SPCs, who have an interest in the installation of energy saving devices.

One such third party is Government. Governments may wish to reduce electricity usage, in order to reduce the greenhouse gas emissions associated with electricity production. Governments may also wish to reduce or delay expenditure on electricity generation and distribution infrastructure which are required by increasing energy usage.

Another group of third parties are energy utilities: electricity generators, distributors and retailers. Either through requirements placed upon them by governments having the motives described above, or in order to meet their own requirements for cost reductions, these utilities may wish to reduce electricity consumption.

In other circumstances, the third party might be a building owner who is responsible for the energy consumption of tenants.

Such third parties may be willing to provide incentives for the installation of energy saving devices in domestic and commercial premises.

Thus there may be installed energy saving devices in circumstances where a third party other than the installer and the user of the connected electrical devices has an interest in knowing the installation status of the device.

The user interface includes a Verification App which is able to provide usage data describing the functioning of the SPC to a monitoring entity which may be, or may act in conjunction with, such a third party.

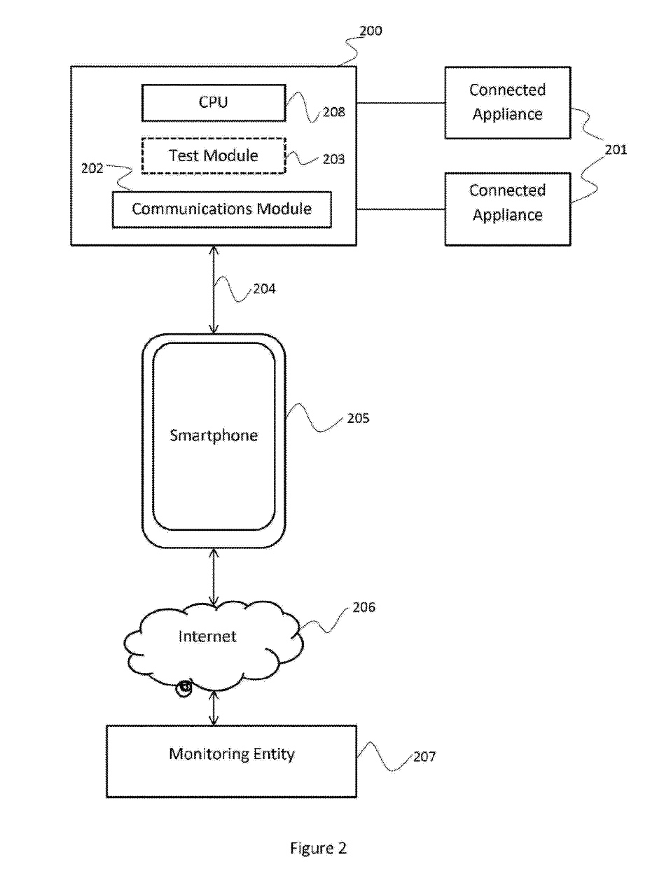

FIG. 2 is a block diagram representation of the operational modules of an SPC such as that of FIG. 1 when there is an installation installed in response to a third party incentive, or under the auspices of an installation program incentivised by such a third party.

SPC 200 provides electricity to attached appliances 201 connected to controlled outlets of the SPC, cutting the electricity supply to save energy as described in the description of FIG. 1.

The SPC 200 includes a Communications Module 202, which allows wireless communication with an external, user supplied, processing and display unit 205 via wireless link 204. In the illustrated installation this processing and display unit 205 is a smartphone, but, without limitation, a tablet, laptop or desktop computer may also be used. A dedicated display and processing unit may also be provided, which in other embodiments, may be part of the SPC or physically connected to the SPC, in which case the wireless link may be absent.

The wireless link 204 may be provided by any convenient means, including without limitation, Bluetooth, wifi and infra-red. The link may also be replaced by a pluggable wired link.

The smartphone 205 provides communication via communications network 206 to monitoring entity 207.

In a preferred embodiment the communications network 206 is the public internet, but other communications networks such an intranet or a ZigBee mesh network may be used.

In a further embodiment, the communications module may establish a data link to the monitoring entity by using a wireless router which already exists in the household to gain access to the public internet.

In a further embodiment, the communications module may establish a data link to the monitoring entity by accessing a cellular data network to gain access to the public internet. Depending on the nature of the cellular network, this may require the communication module to include a sim card.

The monitoring entity 207 is a third party as described above, such as an energy retailer, other energy utility, or government agency, which has an interest in confirmation of installation, or is an entity which acts for, or in conjunction with, such a third party. This may be because the third party pays an incentive for such installations, or because the third party undertakes or incentivises programs of installation of such energy saving devices, and the third party wishes to monitor the efficacy of such programs.

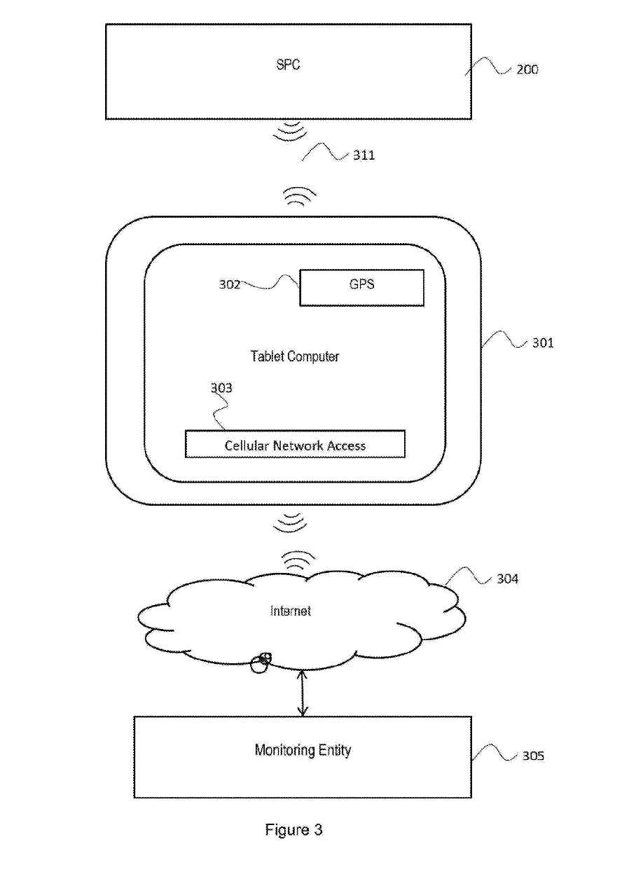

Referring now to FIG. 3, the SPC may be delivered and installed by a qualified installer. The SPC 200 has Bluetooth communications link 311. The installer has a processing and display device 301. This may be without limitation, a smartphone, a mobile computing device, a laptop computer or a dedicated computing device but in the illustrated embodiment is a tablet computer. The tablet computer 301 runs an Installer Verification App. The tablet 301 includes a GPS receiver 302. The tablet includes or has access to a cellular network communication module 303. This provides access to the public internet 304. Via this internet connection, the Installer Verification App is able to communicate with monitoring entity 305. In other embodiments, access to the internet may be provided in any convenient manner, including without limitation, a wi-fi network, wired ethernet and a local mesh network.

In some cases, simply knowing that an energy saving device has been installed at householder premises will be sufficient for the third party incentive provider to provide the incentive. In such a case, the information required by the monitoring entity in order to verify that an installation has taken place may be no more than a household identifier, and confirmation that an energy saving device is operational at that address. The household identifier may be the householder's name and address, or any other convenient identifier which sufficiently identifies the household. In an embodiment, the display and processing device 205 includes a GPS capability The Installer Verification App retrieves the current GPS location of the smartphone 205, along with a Verification code which is available to the Installer Verification App as soon as the App makes a connection to the SPC. It may, for example be the MAC address of the communication module of the SPC. The information passed to the monitoring entity includes the GPS location, the verification code and the householder name or other identifier. The monitoring entity or the third party may further verify the installation by verifying that the GPS location is at least approximately the householder's address as previously recorded for that householder.

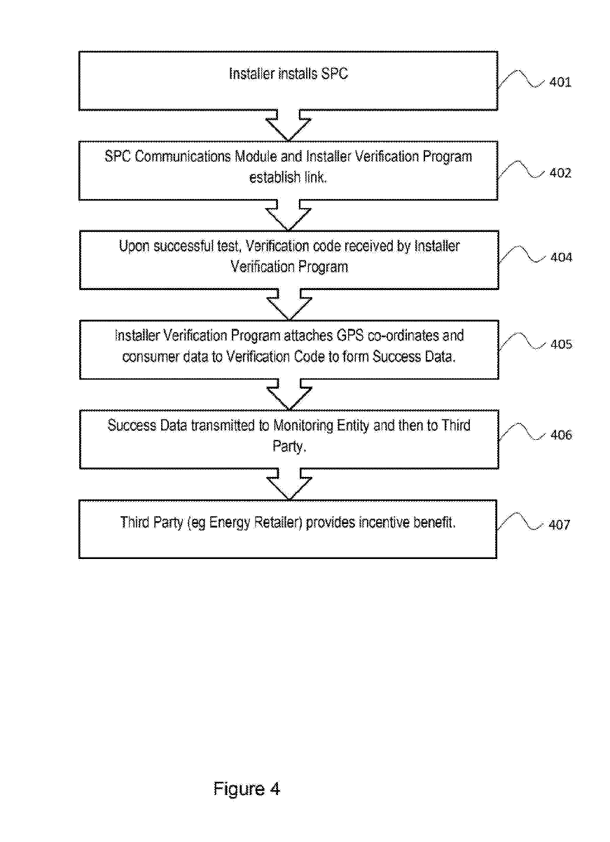

Referring now to FIG. 4, there is a flowchart of the procedure for installation where installation is performed by a qualified installer.

The use of a qualified installer to perform installations of SPCs on behalf of energy retailers or other interested third parties has the advantage that compliance with correct installation is likely to be higher since the installer will definitely attempt the installation, which some householders will not if an SPC is simply provided to them. Further an installer will have the skills to complete the installation, and may be trained in correct installation procedures. The installer can identify whether a correct installation of an energy saving device can be undertaken in a given situation, and can verify that such an installation has taken place.

At step 401, the installer provides the SPC at the householder premises. The installer then connects audio visual devices of the household to the SPC in a manner which is consistent with the requirements of the third party for an installation which attracts an incentive, or simply in accordance with the installation instructions for the SPC.

The SPC and the tablet 301 establish communications, step 402. Communications are established over Bluetooth link 211.

Upon connection to the Installer Verification App the SPC communicates a verification code to the Installer Verification App, step 404. The communication module then communicates a unique verification code to the installer. This verification code is unique to the particular energy saving device unit which is installed. This may be a supplied unique identifier, supplied by the SPC manufacturer and embedded in the SPC at manufacture. It may be an inherently unique identifier of the SPC or a part of the SPC, such as the media access control (MAC) address of the communications interface of the SPC. The fact of a successful installation and/or this verification code is then recorded by the installer or the Installer Verification App.

The Installer Verification App then attaches GPS co-ordinates, obtained from GPS receiver 302 to the verification code to form 405 the Success Data. Also included in the Success Data may be identification data, being any data concerning the household or the householder which the monitoring entity wishes the installer to collect, which the householder is willing to give. The Success Data is conveyed 406 to the monitoring entity and the third party incentive provider, for example an energy retailer.

The third party incentive provider then provides 407 the incentive benefit. The benefit may be provided to the householder, the monitoring entity or the installer depending upon the details of the relationship between these entities.

Additional data in addition to the verification code may be provided by the Installer Verification App to the monitoring entity's verification system. This may include the location of the tablet when the verification code was received, as provided by the GPS receiver 302. This prevents an installer from fraudulently validating a number of SPCs at one location, rather than installing them in customer premises.

The data may include the identity of the qualified installer, in the case that a pool of energy saving devices with a known pool of verification codes is provided to each qualified installer. In such a case, even a valid verification code would not result in the third party incentive payer accepting the installation as one where an incentive would be paid if provided by someone other than that qualified installer.

The monitoring entity or the interested third party then takes the verification code and enters it into a database of previously provided verification numbers which are unique to each of the SPCs that the third party has caused to be installed. Upon a successful match the third party can then have a greater level of confidence that the installation of the energy saving device occurred and was carried out in the appropriate manner to ensure that, at least on initial installation, the energy saving device was brought into correct operation or active use.

It is not necessary for the Installer Verification App to be in constant communication with the monitoring entity's systems. The tablet may store the verification data for bulk downloading at a later stage, such when the qualified installer returns back to a base station.

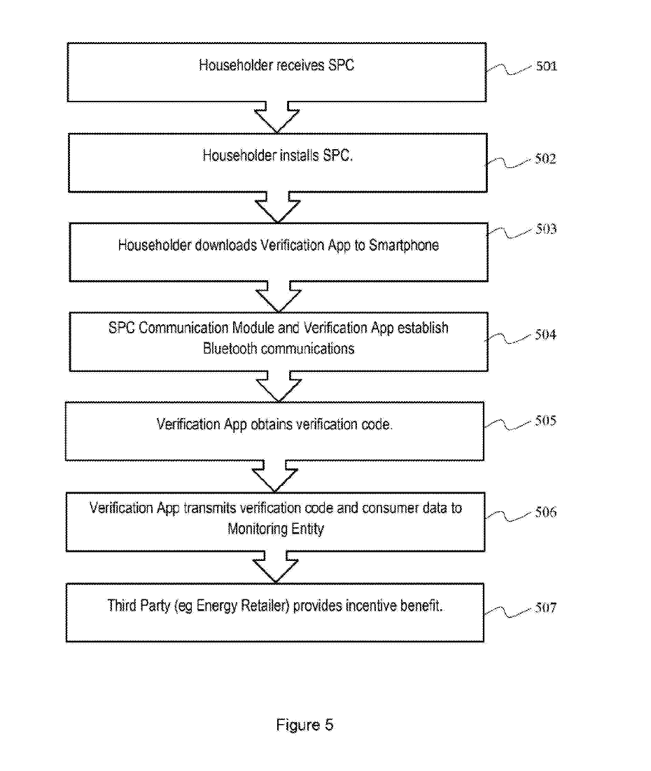

The SPC may installed by a householder themselves. Turning to FIG. 5, there is a flowchart of a self-install by a householder.

The householder receives 501 an SPC. The third party incentive provider may make these available, or the SPC may be provided by the monitoring entity. For example an energy retailer may mail out SPC devices to its customers, or a government body may distribute SPC devices to low income households. The householder may also purchase an SPC.

The householder then installs the SPC, step 502.

In order to control the SPC, and to provide communication to the monitoring entity, a Verification App is downloaded by the householder to the householder's own device, such as a smartphone or tablet computer, at step 503. The Verification App will establish communications with the monitoring entity, and with the SPC. The Verification App may also provide a user interface which allows the householder to control and/or to monitor at least some functions of the SPC.

The householder may be asked to configure the Verification App and to provide identification data which will identify them to the monitoring entity and the third party incentive payer. The householder may need to establish an account with the monitoring entity and provide such details as name, address and utility account number.

In an embodiment where the SPC has been sent to the householder by a utility, all necessary customer details may be known to the utility. The required identification data details may be encoded into a bar code or a QR code, which may be read by the smartphone app, meaning that data entry by the householder is not required.

Communication is established 504 between the newly installed SPC and the Verification App.

The Verification App obtains 505 a verification code from the SPC. This verification code is unique to the particular energy saving device unit which is installed. This may be a supplied unique identifier, supplied by the SPC manufacturer and embedded in the SPC at manufacture. It may be an inherently unique identifier of the SPC or a part of the SPC, such as the media access control (MAC) address of the communications interface of the SPC.

Having obtained the verification code indicating an acceptable installation, the Verification App reports the verification code to the monitoring entity, step 506. The third party verifies that the supplied verification code correspond to a valid verification code for an SPC. Upon such verification, the third party provides whatever incentive it has agreed to supply for a successful installation, step 507. This may be direct payment of money to the householder. It may be a rebate on the bill of the householder. It may be not billing the householder for the cost of the SPC. Any other acceptable incentive may be used.

Verification is done by checking the received verification code against a list of valid verification codes supplied by the manufacturer of the SPC or of the communication module to the third party.

Other data may be used to assist with verification, such that all data must be consistent to achieve verification. This data may include a serial number applied to the energy saving device which has a unique relationship to the verification code for that device.

Even in the case where the SPC is installed by an installer, it is preferred that the householder be encouraged to download and set up the Verification App as described above. The Verification App is able to communicate ongoing behaviour of the energy saving device to the monitoring entity. This allows the monitoring entity to verify ongoing installation of the SPC, and to measure the ongoing energy savings made by the installation.

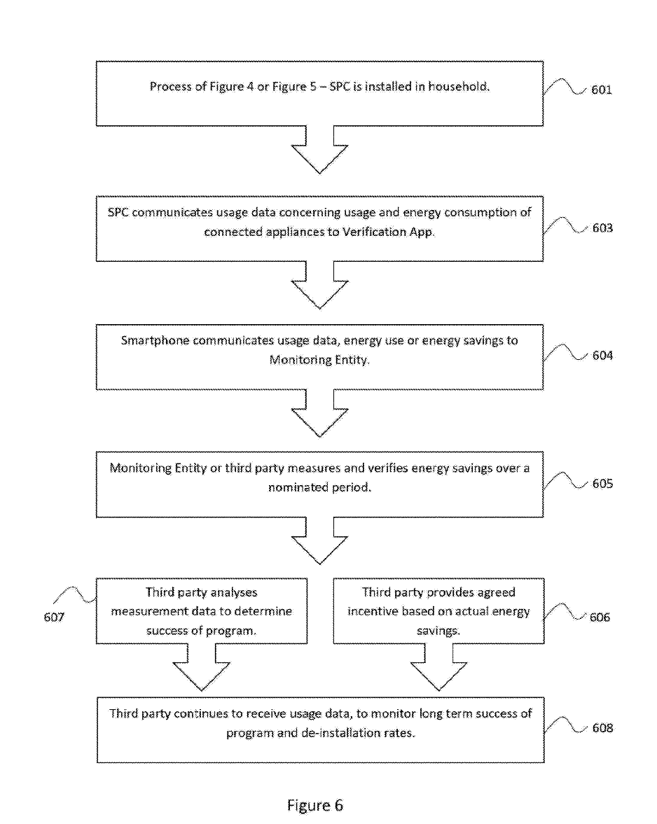

FIG. 6 shows a flowchart of the ongoing measurement and verification of the SPC installation and the energy savings from the installation.

The SPC is installed 601 in a household by a qualified installer or self-installed by a householder, as previously described. An initial incentive for installation may be paid by a third party with an interest in the installation of energy saving devices. As part of the installation process, the householder has installed the Verification App on a computing device of the household. This may be any suitable device including without limitation a tablet computer, a desktop computer and a smartphone. In a preferred embodiment it is a smartphone belonging to a member of the household.

The SPC runs normally, cutting power to the connected appliances when the television is detected to be in a standby mode.

The SPC is in data communication, at least at some times, with the Verification App. The SPC communicates 603 usage data to the Verification App. The usage data describes the power consumption of the devices connected to the SPC, as measured by the power sensor. The usage data may also include details of the function of the SPC, that is when and for what reason the SPC has removed power from the Monitored and Controlled Outlets. The usage data may also include the verification code. Where the verification is the MAC address of the SPC communication module, or another identifier of the communication link, this information is included automatically.

The smartphone or other computing device running the Verification App communicates 604 the usage data to a monitoring entity. The SPC or the Verification App may calculate the actual energy savings and this information may be transmitted to the monitoring entity.

The monitoring entity may analyse the usage data, or may pass the usage data directly to a third party incentive payer for analysis, at step 605. The usage data is analysed to determine the amount of energy saved by the actions of the SPC. The amount of energy used by the devices plugged in to the SPC is included in the usage data. The energy use of the appliances connected to the SPC, when the television is in both active standby and low power standby can be determined. The amount of time that the actions of the SPC has prevented the connected devices from remaining in these power states can be calculated or estimated.

The third party incentive provider may have agreed to provide an ongoing incentive 606, related to the continuing installation of the SPC and/or to the actual savings identified as being made by the SPC installation. The results of the measurement of the energy savings, combined with the verification code which indicates that the SPC is still installed, is used by the third party incentive payer to decide whether to make an incentive payment, and in what amount.

Alternatively, or in parallel, the third party incentive payer analyses 607 the measurement and verification data received in order to assess the success of a program of installations of energy saving devices. The third party may have undertaken or incentivised a program of installations of energy saving devices over the entire geographic area of its interest, a specific geographic area, or a specific market segment. The measurement and verification data allows the incentive payer to decide if it has spent its money well, and if programs should be extended, continued or cut. It allows the incentive payer to report energy savings, or greenhouse gas emission savings to the payer's stakeholders.

This monitoring may continue 608 for an extended period. Over the longer term, the interest of the monitoring entity and the paying entity may be concentrated on de-installations rates. De-installation occurs when, for whatever reason, the householder ceases to allow the SPC to control appliances. Early de-installation is likely to indicate user frustration with the SPC, later de-installation may simply mean that the householder has disconnected appliances for example to replace or move them, and is unable or unmotivated to reconnect them.

The third party which is providing an incentive for the installation of energy saving devices may wish to be certain that an energy saving device, such as an SPC, has been correctly installed prior to providing the incentive.

Referring again to FIG. 2, the SPC 200 may include a Test Module 203. This may be provided as software running on the CPU 208, or may be provided by a separate processor or dedicated circuitry. In a further embodiment, the Test Module may be provided as software running on the processing and display unit 205.

The Test Module 203, is able to perform tests to verify that the energy saving device is installed and installed correctly. The third party providing incentives for the installations may require that installations meet certain criteria in order to qualify for the incentives.

In an embodiment, plugging in the energy saving device causes the Test Module to become active. The Test Module then monitors the SPC sensors and the activities of the CPU 208. The Test Module analyses these inputs to determine that electrical devices are connected to the energy saving device and that those electrical devices are of acceptable types.

For example, it may be determined that power savings sufficient to justify providing the incentive for the installation of the energy saving device will only be achieved when the connected electrical devices are of a type which includes a standby function, during the activation of which, power can be cut to one or more of the sockets 201 to save energy. A television set may meet these criteria while a lamp would not. The variation with time of the power drawn through the energy saving device, as detected by the sensors, would vary between these two devices.

The Test Module is able to determine whether the characteristics of the electrical devices connected to the energy saving device are such that the installation is considered acceptable to the third party. This determination may be based on a period of monitoring of the activity of the installation during a period of normal operation.

In a further alternative embodiment, the Test Module may monitor fluctuations of the power drawn through the energy saving device. The power drawn by active devices such as computers or television sets will include fluctuations, whilst passive loads such as room heaters and lights will not. The Test Module detects the magnitude and/or duration of the fluctuations to ensure that a threshold level is reached which indicates the presence of a device which is acceptable as part of a correct installation.

Alternatively to or in combination with measurement of absolute values and fluctuations of power and/or current; the Test Module may accumulate a value of total energy consumption by the connected electrical devices. A determination that a successful installation has been made occurs only after a pre-determined value of energy consumption has been accumulated. The time to making a determination in this case may depend on the types of devices connected and their power consumption.

A control may be provided to cause the Test Module to undertake testing, or the Test Module may monitor the sensor outputs at all times, or at selected times.

The Test Module communicates the results of the testing to Communications Module 202. The function of the Communications Module is to communicate to the third party the result of the installation testing. This communication is made in such a manner that it is difficult for a user to report an incorrect or improper installation as a correct installation for which the incentive will be made available. This ensures that the energy supplier or other third party will only pay the incentive in cases where the energy saving device has been installed in a manner which will achieve the desired power savings, or at least will meet the requirements for a valid installation set out by the third party.

In a preferred embodiment, the communications module receives a validation signal from the Test Module indicating that the test result is that the installation is acceptable. The communication module then communicates a unique verification code to the installer. This verification code is unique to the particular energy saving device unit which is installed. This may be a supplied unique identifier, supplied by the SPC manufacturer and embedded in the SPC at manufacture. The verification code should not be easily discovered unless the test regime has been complied with and has produced a successful result. As such, a MAC address of the communications interface of the SPC is less useful as a verification code in this case.

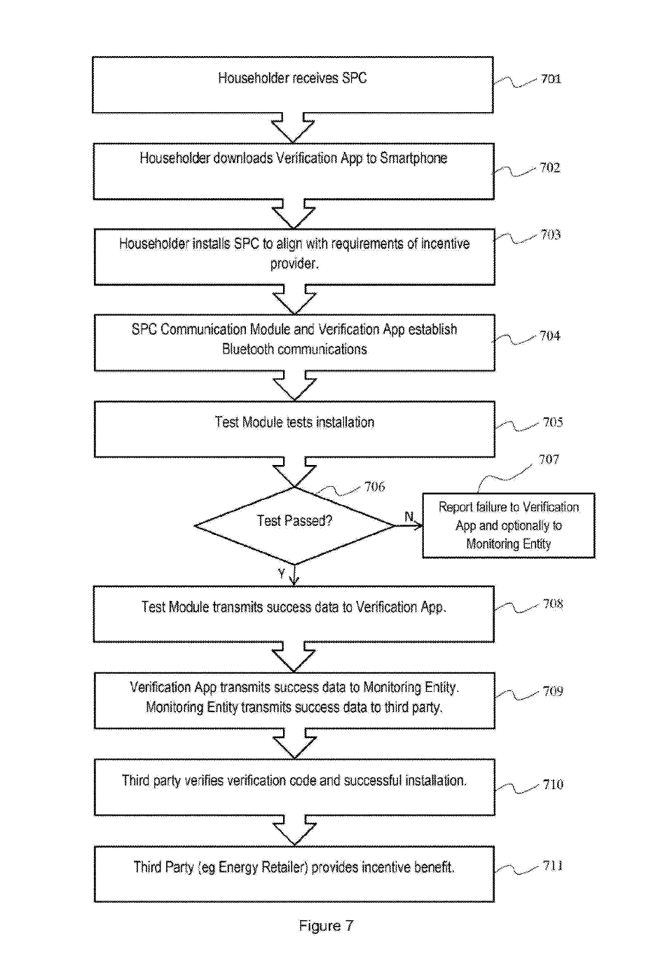

FIG. 7 is a flowchart showing the procedure used to verify the installation of an SPC when the SPC is self-installed by a householder.

At step 701, the householder receives the SPC. This may be by distribution by the third party incentive provider, or by purchase.

In order to control the SPC, and to provide communication to the third party, a Verification App, as previously described, is downloaded to the householder's own device, such as a smartphone or tablet computer at step 702. The Verification App will establish communications with a monitoring entity which has or permits communication to a remote computer system allowing verification of a correct installation by a third party incentive provider. The Verification App may also provide a user interface for the SPC.

The householder may be asked to configure the Verification App and to identify themselves to the monitoring entity. The householder may need to establish an account with the remote computer system of the monitoring entity or the third party incentive provider, and provide such details as name, address and utility account number.

In an embodiment where the SPC has been sent to the householder by a utility, all necessary customer details may be known to the utility. The required details may be encoded into a bar code of a QR code, which may be read by the smartphone app, meaning that data entry by the householder is not required.

The householder then installs the SPC, step 703. The incentive provider may have stipulated that only certain installations will attract the incentive. For example, there may be a requirement that an SPC such as that of FIG. 1 have control of power to say two appliances in addition to the television. Where an SPC adapted for use with a computer installation is installed, there may be a requirement that the total standby power drawn by the peripherals supplied with power through the SPC exceed a certain value. The householder ensures that their installation meets any such requirements.

At step 704, communication is established between the newly installed SPC and the Verification App. This may occur before, after or in parallel with testing 705.

At step 705, the Test Module tests the installation as described previously.

The Test Module then determines, at step 706, whether the installation is a valid installation for the purposes of receiving an incentive from the third party.

The Test Module may also determine the power use characteristics of the installation, such as power consumption when in active use and power consumption when in a standby state. This data may be used, either by the SPC or by an energy retailer to determine the potential energy savings which the SPC is able to make. This may be used to determine the quantum of any incentive paid for the installation of the SPC.

Where the installation is not valid, 707, the Test Module communicates to the Verification App that the requirements have not been met. The Verification App will then report this result to the customer. The Verification App may report this to the third party verification service.

Where the result of the test is that the installation complies with the incentive provider's requirements, the Test Module reports this to the Verification App, step 708. The Test Module transmits a unique verification code, as described above, to the Verification App.

Having obtained the verification code indicating an acceptable installation, the Verification App reports the verification code to the third party, step 709. The third party verifies that the supplied verification code correspond to a valid verification code for an SPC, step 710. Upon such verification, the third party provides whatever incentive it has agreed to supply for a successful installation, step 711. This may be direct payment of money to the householder. It may be a rebate on the bill of the householder. It may be not billing the householder for the cost of the SPC. Any other acceptable incentive may be used.

Verification is done by checking the received verification code against a list of valid verification codes supplied by the manufacturer of the SPC or of the communication module to the third party.

Other data may be used to assist with verification, such that all data must be consistent to achieve verification. This data may include a serial number applied to the energy saving device which has a unique relationship to the verification code for that device.

The third party may not undertake the verification, but may communicate the verification code to the manufacturer of the SPC or of the communications module to allow them to perform the validation.

The party performing the validation keeps records of which verification codes have been presented for validation, to prevent re-use of the verification code in order to gain an incentive without performing a correct installation.

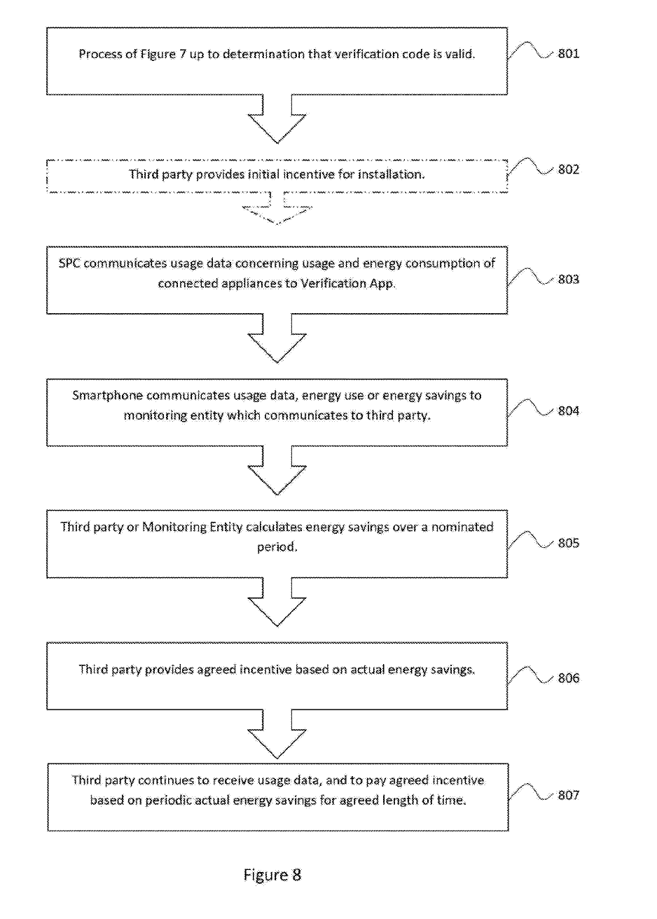

Referring now to FIG. 8, there is shown a flowchart of a system wherein the third party provides incentives in a staged manner in order to provide an ongoing incentive for an end user to keep the SPC installed.

The initial installation of the SPC occurs at step 801. Verification of the installation of the device is provided to the third party, as described in FIG. 3. In an embodiment, the verification is by any means acceptable to the third party, which may or may not include the use of a verification code. In an embodiment, the third party will accept the establishment of communication with the SPC as evidence of installation.

The third party may provide an initial incentive for the installation, step 802, as described for FIG. 7. The provision of an initial incentive payment is optional. The third party may provide a payment to fully or partly cover the cost of the supply and installation of the SPC.

The SPC then continues to function in the normal manner. Continuously, periodically or occasionally, the SPC communicates usage data, being details of use to the Verification App on the householder's smartphone, step 803. This may be in the form of raw usage data, that is the power measured as being consumed by the devices connected to the monitored outlets and the times of operation of the SPC to remove power from the controlled outlets. Usage data may include calculated energy savings for the period concerned.

The usage data, if not communicated continuously, may be communicated periodically at any convenient period which may be a few seconds, to many days or weeks.

The Verification App communicates the usage data to the monitoring entity at step 804. There is a measurement and verification system, which may be provided by the monitoring entity or the third party incentive payer, which receives the usage data which includes, or permits the calculation of, the energy savings made by the installation of the SPC over a nominated period, step 805.

The third party receives the output of the measurement and verification system and is now confident that the SPC is installed and continues to be in use, and has provided a certain energy saving. The third party now provides an agreed incentive, based on the actual energy savings achieved by the installation of the low energy consumption device at step 806.

This communication of usage data to the third party continues periodically for an agreed period, or indefinitely, with the third party continuing to provide an agreed incentive for the amount of energy saved by the installation of the SPC for that period, step 807.

In general, the incentive payment will vary by the amount of energy saving reported for a period, but it may also vary by the time since installation, by the cost of electricity for the period, or by any other agreed factors.

In an embodiment, only the verification code may need to be communicated periodically to the third party verify that the SPC device is still in use and to ensure that the user continues to receive the incentives.

The continuing installation of the SPC may be monitored as previously described, even where ongoing incentives are not paid. The ongoing monitoring may be used by the energy retailer to determine the effectiveness of an SPC installation program, by determining the rate of de-installation of the SPCs.

Testing by the Test Module 203 may also be undertaken when the energy saving device is installed by a qualified installer. Requiring a verification ensures that a qualified installer, who is likely to be paid per installation, does not attempt to pass of installations where the incentive payer's requirements cannot be met, as verified installations.

Where a qualified installer has installed the SPC, but a test is required, then, once the energy saving device is connected to the appropriate devices, the installation is tested, for compliance with the incentive requirements, as described for an installation by a householder. With an installer present, test steps which require physical manipulation of the connected appliances may be undertaken, which would be difficult to require of a householder undertaking a self-installation. The installer may initiate a test procedure in which at least the main electrical device, usually the television, is taken through its various power states, such as off, on and/or standby over a pre-defined period of time. The energy saving device then verifies that the fluctuations in power and/or current and/or voltage, follow a pattern which indicates successful installation. Alternatively, no explicit testing may be made, but the energy saving device may monitor the normal use of the electrical devices connected to the SPC for a time to make the same determination.

The results of the testing are communicated to the Installer Verification App and hence to the monitoring entity and the incentive payer as for a self-install.

The description of the invention has been presented in the context of a particular energy saving device, being a standby power controller, also known as an advanced power strip. However, any energy saving device having a processing capability may be adapted to perform the invention. This includes devices which save energy by virtue of using less energy that conventionally installed alternatives. The method of the present invention now provides for a new way in which the installation of electronic devices, such as energy saving devices, can be verified as being installed currently and further than such installations are within the parameters of the intended use. This provides the energy retailer and any other party, such as a Government body, a higher level of confidence in the successful installation of such devices than has been available previously.

Additionally, the present invention reduces or removes the requirement for additional audits or checks, thus saving substantial time and money to those that either distribute or financially support the distribution of such energy saving devices.

Although the invention has been herein shown and described in what is conceived to be the most practical and preferred embodiments, it is recognized that departures can be made within the scope of the invention, and that various modifications may be made in details of design and construction [and process steps, parameters of operation etc without departing from the scope and ambit of the invention.

1.-21. (canceled)

22. An energy saving device for installation in a household, the energy saving device including a communication module configured to transmit a verification code to a co-located processing device upon successful installation of the energy saving device, whereby the verification code verifies correct installation of the energy saving device.

23. The energy saving device of claim 22 wherein the communications module is further configured to transmit usage data characterizing the operation of the energy saving device to the co-located processing device following successful installation of the energy saving device, whereby the usage data verifies ongoing use of the energy saving device.

24. The energy saving device of claim 22 wherein the communications module is configured to transmit the verification code to a remote monitoring entity via the co-located processing device.

25. The energy saving device of claim 24 wherein the co-located processing device is a smartphone.

26. The energy saving device of claim 22 wherein the verification code is unique to the energy saving device, such that no other energy saving device shares the verification code.

27. The device of claim 22 wherein the verification code is unique to a set of energy saving devices, of which the energy saving device is a member.

28. The energy saving device of claim 22 wherein the verification code includes identification data uniquely identifying a communication transceiver of the energy saving device.

29. The energy saving device of claim 28 wherein the verification code further includes location data identifying a geographical location of the household in which the energy saving device is installed.

30. The energy saving device of claim 22 wherein the energy saving device is a standby power controller.

31. The energy saving device of claim 22:
a. configured to
(1) be connected to:
(a) a power outlet, and
(b) an electrical device, the electrical device drawing power through the energy saving device,
(2) perform at least one installation verification test,
b. wherein the communication means is configured to transmit the verification code to the co-located processing device when a result of the installation verification test indicates that correct installation of the energy saving device has occurred.

32. The device of claim 31 wherein the installation verification test includes:
a. monitoring power drawn through the energy saving device, and
b. verifying whether the drawn power conforms to a predetermined pattern indicative of correct installation of the energy saving device.

33. The device of claim 32 wherein the predetermined pattern is one defined by power drawn through the energy saving device by a connected electrical device of a predetermined type.

34. The device of claim 32 wherein the predetermined pattern is one defined by a total energy consumption which exceeds a predetermined threshold.

35. An energy saving device for installation in a household, the energy saving device including a communications module configured to transmit:
a. a verification code identifying the energy saving device, and
b. usage data characterizing the operation of the energy saving device,
to a remote monitoring entity upon installation of the energy saving device in the household, whereby the verification code and the usage data may verify correct installation and ongoing use of the energy saving device.

36. The energy saving device of claim 35 wherein the verification code uniquely identifies a communication transceiver of the energy saving device.

37. The energy saving device of claim 36 wherein the verification code further includes location data identifying a geographical location of the household in which the energy saving device is installed.

38. The energy saving device of claim 35 wherein the communications module is configured to transmit the verification code and the usage data to the monitoring entity via a wireless communication link to a router of the household, whereby the router transmits the verification code and the usage data to the monitoring entity via the internet.

39. The energy saving device of claim 35 wherein the communications module is configured to transmit the verification code and the usage data to the monitoring entity via a cellular data network.

40. The energy saving device of claim 35 wherein the communications module is configured to transmit the verification code and the usage data to the monitoring entity via a mobile computing device.

41. The energy saving device of claim 40 wherein the mobile computing device is a smartphone.

42. A method of using the energy saving device of claim 35 including the steps of:
a. installing the energy saving device in a household,
b. transmitting the usage data to the monitoring entity via the communications module of the energy saving device, and
c. analyzing the usage data to determine energy savings attributable to the installation of the energy saving device in the household.

43. The method of claim 42 further including the step of a third party:
a. determining the success of the installation from the determined energy savings, and
b. paying an incentive for the installation of the energy saving device.

44. A method of using the energy saving device of claim 35 including the steps of:
a. installing the energy saving device in a household between an electrical mains and an electrical device,
b. monitoring power drawn through the energy saving device, and
c. verifying whether the drawn power conforms to a predetermined pattern indicative of correct installation of the energy saving device.
